(19) United States
(12) Patent Application Publication
(10) Pub. No.: US 2023/0134796 A1
(43) Pub. Date: May 4, 2023

(54) NAMED ENTITY RECOGNITION SYSTEM FOR SENTIMENT LABELING

(71) Applicant: Glipped, Inc., Santa Monica, CA (US)

(72) Inventors: Saumya Bhatnagar, Santa Clarita, CA (US); Ella Elizabeth Lucas, San Diego, CA (US); Geoffrey Rathinapandi, Santa Monica, CA (US); Hardika Narula, Santa Monica, CA (US); Pavithra Ezhilarasan, Torrance, CA (US)

(21) Appl. No.: 17/515,314

(22) Filed: Oct. 29, 2021

(51) Int. Cl. G06F 40/295; G06F 40/30; G06F 40/117; G06F 40/253; G06F 40/143; G06F 3/0482; G06N 5/02

(52) U.S. Cl. CPC G06F 40/295; G06F 40/30; G06F 40/117; G06F 40/253; G06F 40/143; G06F 3/0482; G06N 5/022

(57) ABSTRACT

A named entity recognition system performs analysis on textual information and identifies intents, sentiments, or actionable items. The system develops a training dataset for training a machine learning model. The data preparation process includes gathering textual data, cleaning the dataset, masking sensitive information, and mapping each textual content item to a set of predefined named entities. The system further generates a template that includes guidelines and criteria defining each label. The system provides instructions to human classifiers for labeling training data and identifying keywords that encapsulate meaning of the label. The resulted training dataset includes value pairs, each value pair including a label and corresponding keywords. The system trains a machine learning model pipeline using the training dataset. The named entity recognition system further includes a user interface and presents the labels and highlighted the identified keywords that encapsulate meaning of the label to the user through the user interface.

### BACKGROUND

This invention relates generally to sentiment labeling, and more particularly to sentiment labeling of texts using a named entity recognition system.

People receive an extensive amount of information each day, through various sources such as texts, emails, social media, websites, audios, videos, phone calls, etc. and people need to extract meaningful and important information from all the data received. However, the massive amount of information can be overwhelming to process. For example, an organization that provides service to a large number of customers may receive from customers a large set of data each day such as emails, support tickets, phone logs, online reviews, etc. To develop a comprehensive understanding of customer needs based on the received raw data may be a time-consuming and labor-intensive process. Important information may be overlooked due to the large amount of data to process and to extract information from. Accordingly, there is a need for an intelligent and automated system that can provide meaningful insights based on the received textual information.

### SUMMARY

Systems and methods are disclosed herein for a named entity recognition system that performs analysis on textual information and identifies intents, sentiments, or actionable items.

The named entity recognition system may first develop a training dataset for training a machine learning model. The data preparation process may include gathering textual data, cleaning the dataset, masking sensitive information, and mapping each textual content item to a set of predefined named entities (may also be referred to as labels.) A named entity (or label), as used herein, may refer to a real-world object, such as a person, location, organization, product, an intent, a task, a type of sentiment, an actionable item, an accomplished item, etc. The set of predefined named entities may be developed by individuals with expertise in related fields. In other embodiments, the named entities may be extracted from the dataset by an automated process using a machine learning model. The named entity recognition system may further generate a template (may also be referred to as a guide) that includes guidelines and criteria defining each label. The named entity recognition system may provide instructions to qualified human classifiers for labeling training data such as texts based on the template, where human classifiers may assign one or more labels to texts and identify keywords that encapsulate the meaning of the label. The resulted training dataset include value pairs, each value pair including a label and corresponding keywords.

Using the training dataset, the named entity recognition system trains a machine learning model pipeline that includes multiple sub-models for performing different functionalities, such as tokenizing data, part-of-speech tagging, parsing data, assigning lemmas, applying transformers, etc. The trained model is then saved and used in a deployment process which generates predictions and/or classifications and presents the results through a user interface. Users of the named entity recognition system may use the interface to view textual information and corresponding identified labels that indicate potential actionable items or identify customer needs. The named entity recognition system may further mark keywords corresponding to the label within the received textual data. The named entity recognition system may present the labels and highlighted the identified keywords that encapsulate the meaning of the label to the user through the user interface. The named entity recognition system may further distinguish polarities among labels by providing visually distinguishable characteristics between positive and negative labels (e.g., using red and green tags.) The positive and negative labels may be further associated with a sentiment score that indicate a level of polarity associated with the label. Furthermore, through the user interface provided by the named entity recognition system, a user may filter on one or more specific labels to view a type of information (e.g., received messages related to product usage issues.)

The disclosed named entity recognition system provides multiple advantageous technical features for efficient analysis of textual data. For example, the named entity recognition system gathers multiple types of textual information for a comprehensive understanding of customer needs, such as any communication or interaction associated with customers including but not limited to emails, phone tickets, webinar transcripts, reviews, notes, etc. Further, the named entity recognition system trains a machine learning model using a training dataset that is developed through a specific process. The training data preparation process may first involve defining appropriate labels (or named entities) and developing a guide with criteria that define the labels. The guide may include samples and corresponding guidelines for each label. Qualified human classifiers may use the guide as a guidance for labeling texts and identifying keywords associated with the label. The labeling process may also be automated using machine learning model. Through the specific preparation process, the training dataset comprises comprehensive information associated with customers but also protects customer privacy by removing sensitive information. The training dataset also helps to train the machine learning model to make accurate predictions because the training dataset is generated based on a comprehensive guide with a set of well-developed and appropriate labels. Moreover, the named entity recognition system provides a user interface through which a user may view labeled texts and highlighted keywords for a more efficient information extraction and decision making process. The named entity recognition system integrates a view with highlighted keywords presented within the original context and therefore makes it more efficient for the user to extract meaningful information from a large number of texts. Through the user interface, the user may also select and filter on labels and information types and view a specific type of texts based on meaning of texts.

### BRIEF DESCRIPTION OF THE DRAWINGS

FIG. 1 is an exemplary system environment including a named entity recognition system, according to one embodiment.

FIG. 2 illustrates an exemplary embodiment of modules in a named entity recognition system, according to one embodiment.

FIG. 3 illustrates an exemplary embodiment of modules in a data pre-processing module, according to one embodiment.

FIG. 4 illustrates an exemplary training process for a named entity recognition system, according to one embodiment.

FIG. 5 illustrates an exemplary user interface through which a user may access service provided by the named entity recognition system, according to one embodiment.

FIG. 6 illustrates another exemplary user interface through which a user may access service provided by the named entity recognition system, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

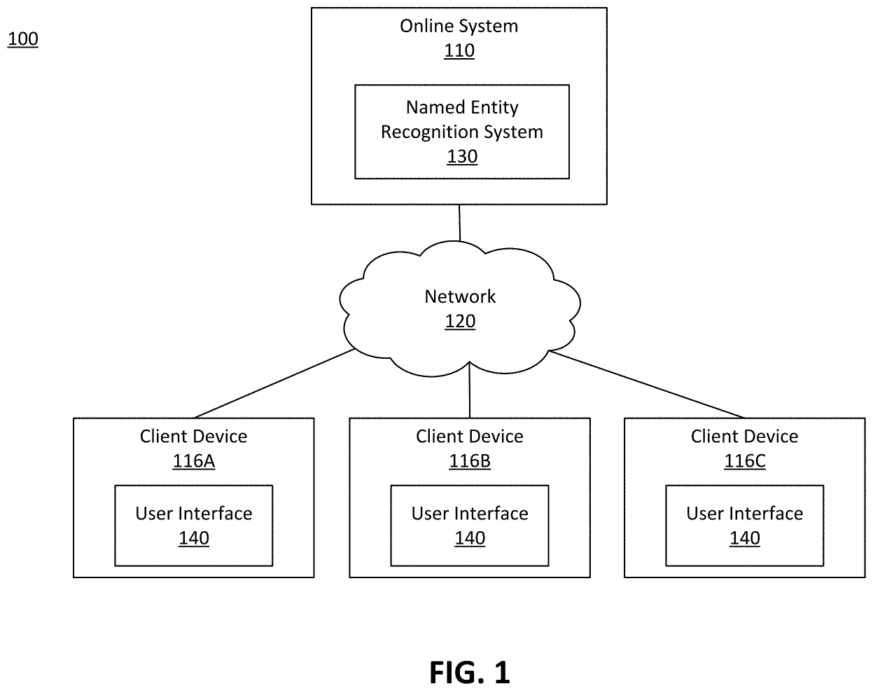

FIG. 1 is a high level block diagram of a system environment for a named entity recognition system 130, in accordance with an embodiment. The system environment 100 shown by FIG. 1 includes one or more clients 116, a network 120, and the named entity recognition system 130. In alternative configurations, different and/or additional components may be included in the system environment 100.

The network 120 represents the communication pathways between the client 116 and named entity recognition system 130. In one embodiment, the network 120 is the Internet. The network 120 can also utilize dedicated or private communications links that are not necessarily part of the Internet. In one embodiment, the network 120 uses standard communications technologies and/or protocols. Thus, the network 120 can include links using technologies such as Ethernet, Wi-Fi (802.11), integrated services digital network (ISDN), digital subscriber line (DSL), asynchronous transfer mode (ATM), etc. Similarly, the networking protocols used on the network 120 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. In one embodiment, at least some of the links use mobile networking technologies, including general packet radio service (GPRS), enhanced data GSM environment (EDGE), long term evolution (LTE), code division multiple access 2000 (CDMA2000), and/or wide-band CDMA (WCDMA). The data exchanged over the network 120 can be represented using technologies and/or formats including the hypertext markup language (HTML), the extensible markup language (XML), the wireless access protocol (WAP), the short message service (SMS) etc. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

The client 116 may include one or more computing devices that display information to users, communicate user actions, transmit, and receive data from the named entity recognition system 130 through the network 120. While only three clients 116A-C are illustrated in FIG. 1, in practice many clients 116 may communicate with the named entity recognition system 130 in the environment 100. In one embodiment, client 116 may be operated in connection with a service provided by the named entity recognition system 130 for entity recognition. For example, client 116 may be operated by a representative of an organization or an entity that provides service to customers, or any other entity interested in generating meaningful insights through big data sets.

The client 116 may receive software services by using software tools provided by the named entity recognition system 130 for sentiment analysis. The tools may be software applications or browser applications that enable interactions between the client 116 and the named entity recognition system 130 via the network 120. The client 116 may access the software tool through a browser or may download the software tool through a third-party application platform, such as an app store. In one embodiment, the client 116 interacts with the network 120 through an application programming interface (API). In one embodiment, the tools may receive inputs from the client 116 which are further used to develop training dataset or to retrain the model. The software tools may include an interface through which the client 116 may provide information or feedback with regard to the prediction results.

The client 116 may include one or more computing devices that are capable of deploying a machine learning model. The client 116 may receive trained machine learning models from the named entity recognition system 130 and perform real-world deployments of the trained machine learning model on a dataset collected based on communications. The deployments of the model may be conducted on one or more devices of the client 116. The model may also be deployed remotely by the named entity recognition system 130 (or a third-party cloud service that is capable of deploying the model), in which case, collected data may be transmitted from client 116 to the named entity recognition system 130 (or the cloud service provider). The named entity recognition system 130 may analyze the collected data and provide outputs back to client 116 (e.g., through a network communication, such as communication over the Internet). Where the model is deployed local to the client, a software package developed and distributed by named entity recognition system 130 may be downloaded to or otherwise transferred to client 116 and may be executed to perform any described post-output analysis.

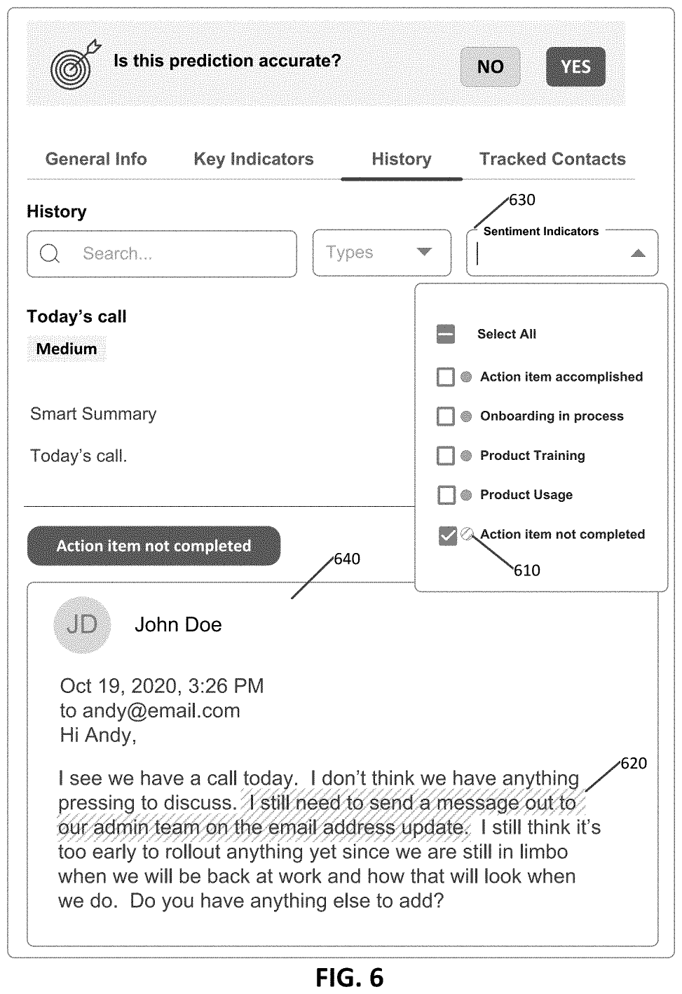

The client 116 may also include one or more computing devices that are capable of displaying a user interface 140 through the computing devices. The client 116 may access service provided by the named entity recognition system 130. The user interface 140 may enable users to view textual information and corresponding identified labels that indicate potential actionable items or identify customer needs. The user interface 140 may also display other information such as polarity, polarity scores, highlighted keywords, predicted health scores, summary of a message, etc. The user interface 140 is discussed in greater detail in accordance with FIGS. 6-7.

The named entity recognition system 130 may manage and provide an end-to-end service for training a machine learning model and making predictions for named entity recognition. The named entity recognition system 130 may develop a training dataset through a preprocessing process that includes gathering textual data, cleaning the dataset, masking sensitive information, and mapping each text to a set of predefined named entities (or labels.) The set of predefined named entities may be developed by individuals with expertise in related fields, or the named entities may be extracted from the dataset by an automated process using a machine learning model. The named entity recognition system may further generate a template (or guide) that includes guidelines and criteria that define each label. The named entity recognition system may provide instructions to qualified human classifiers to label texts based on the template. The named entity recognition system may generate a training dataset that includes value pairs, each value pair including a label and keywords related to the label.

The named entity recognition system may train a machine learning model pipeline that includes multiple sub-models for different functionalities, such as tokenizing data, part-of-speech tagging, parsing data, assigning lemmas, using transformers, etc. The named entity recognition system may deploy the trained model and provide predictions and/or classifications to users through a user interface. The named entity recognition system may mark keywords corresponding to the label within the received textual information and may present the labels and highlighted keywords to the user through a user interface.

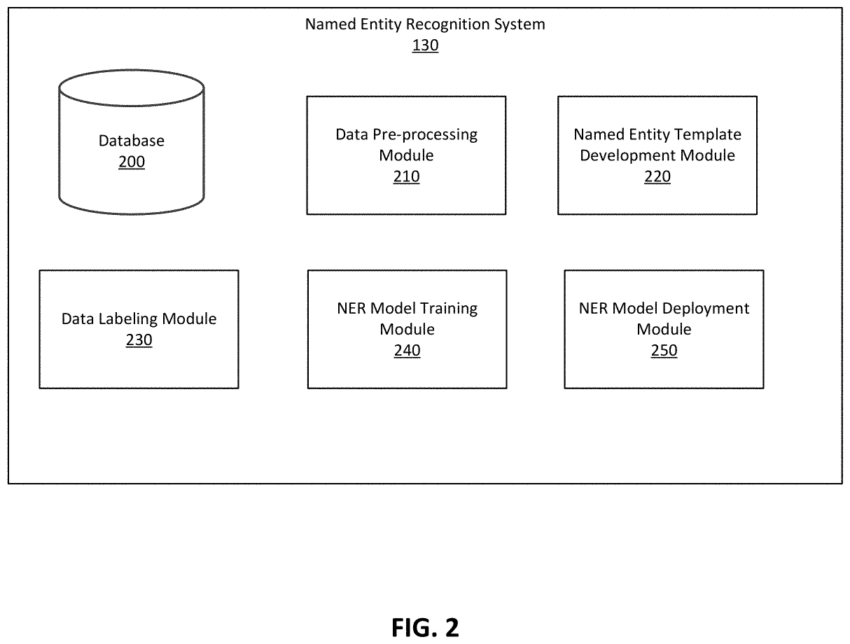

The named entity recognition system may further determine polarities for labels and distinguish the labels by presenting the labels in visually distinguishable styles. For example, the named entity recognition system may determine that there are positive and negative labels, where positive labels tend to indicate a level of positive sentiment (e.g., actionable item accomplished, trying to contact) and the negative labels may indicate a level of negative sentiment (e.g., item not accomplished, renegotiation). To distinguish between positive and negative labels, the named entity recognition system may use visually distinguishable indications for the labels, such as red and green tags. Each positive and negative label may be further associated with a sentiment score that indicates how positive/negative each label is. The named entity recognition system may also enable a user to filter on one or more specific labels to view a type of information (e.g., received messages related to product usage issues.) Further details with regard to functionalities provided by the named entity recognition system 130 are illustrated in FIG. 2.

FIG. 2 illustrates an exemplary embodiment of modules in the named entity recognition system 130, according to one embodiment. The named entity recognition system 130 may include a database 200 for storing raw data, processed data, and guidance/template that defines labels, a data pre-processing module 210 that cleans and prepares data, a named entity template development module 220 that develops a template (or guide) defining entities, a data labeling model 230 that labels textual data based on the template, an NER (named entity recognition) model training module 240 that trains an NER model, and an NER model deployment module 250 that deploys a trained model using real-world data.

The database 200 may store gathered data and templates that define labels. The database 200 may store data gathered for multiple types of interaction or communication data useful for training the model. Various types of data may include but are not limited to emails, phone calls, transcripts, customer reviews, support tickets, notes, webinar transcripts, or any information that can be transformed into texts using the data pre-processing module 210. In some embodiments, the database 200 stores updated data received or feedback on prediction results from the client 116. The database 200 may further store templates that include criteria and examples that define labels. The templates are discussed in further detail in accordance with the named entity template development module 220.

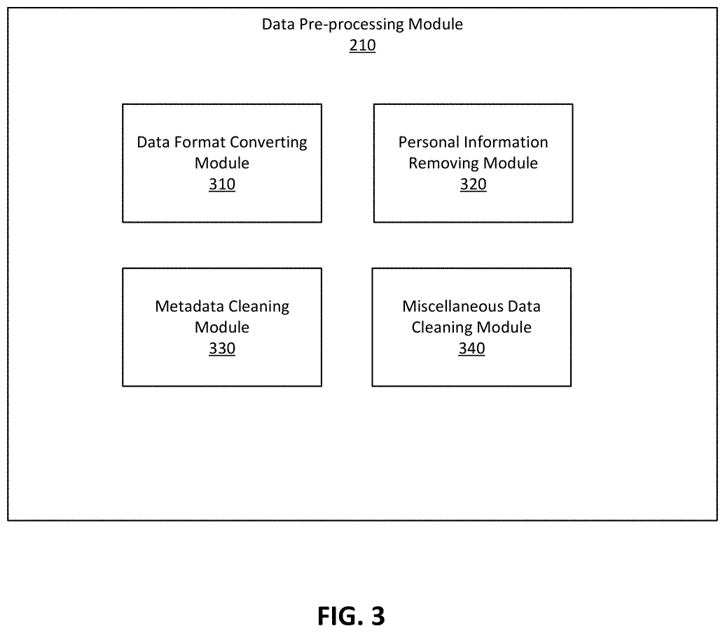

The data pre-processing module 210 cleans and prepares data before a labeling process. FIG. 3 illustrates an exemplary embodiment of various modules in a data pre-processing module, according to one embodiment. The data pre-processing module 210 may include a data format converting module 310 that converts received data to text format, a personal information removing module 320 that removes and/or masks sensitive information, a metadata cleaning module 330 that cleans metadata in data received from the source, and a miscellaneous data cleaning module 340 that further cleans the data using regular expression.

The data format converting module 310 converts received data to a specific format for further processing. In one embodiment, the data format converting module 310 may convert HTML data (HyperText Markup Language) to texts. HTML documents are commonly seen in a nested data structure with texts, headers, metadata, styles, URLs (Uniform Resource Locator), etc. The data format converting module 310 may navigate through the nested data structure and extract relevant information such as texts and save the texts for further processing. In other embodiment, the data format converting module 310 may convert other types of data to textual data. For example, the data format converting module 310 may convert audio to texts or images to texts using optical character recognition.

The personal information removing module 320 removes and/or masks sensitive information. The personal information removing module 320 may replace sensitive information with tags. The personal information to remove may include but is not limited to names, email addresses, addresses, credit card numbers, date of birth, URLs, phone numbers, username and password combinations, social media usernames, Social Security Numbers, Tax numbers, Driver license numbers, or any information that is sensitive or personal. The personal information removing module 320 may replace the personal information with a placeholder. For example, names may be replaced with a tag “[NAME]” or alternatively with fake names, and email addresses may be replaced with a tag “[EMAIL].”

The metadata cleaning module 330 cleans metadata in the data received from data source. As data received from different data sources may include metadata in a specific structure, the metadata cleaning module 330 may remove metadata that persists from the data source. For example, received emails may include metadata such as “From:”; “To:”; “Subject:”; etc. Received data may include other types of annotations depending on data sources. As another example, support tickets may include date and time the ticket is received, ticket number, etc. The metadata cleaning module 330 may use regular expression to find such metadata and further clean the dataset.

The miscellaneous data cleaning module 340 performs other cleaning procedures. In one embodiment, the miscellaneous data cleaning module 340 may clean data using regular expression to identify and remove extraneous punctuations such as commas, question marks, etc. The miscellaneous data cleaning module 340 may further remove line breaks or other formatting that is not used for analyzing meaning of the textual content.

Continuing with the discussion of FIG. 2, the named entity template development module 220 develops a template (or guide) including criteria and examples that define the labels (named entities). A named entity, as used herein, may refer to a real-world object, such as a person, location, organization, product, an intent, a task, an actionable item, etc. The set of predefined named entities may be developed by individuals with expertise in related fields, or the named entities may be extracted from the dataset by an automated process using a machine learning model. For example, the entities may be identified by using a clustering algorithm type of machine learning model. Examples of named entities include but are not limited to Action Item Accomplished, Action Item not Completed, Attempt to Contact/Reschedule, Contract Renegotiation, Executive Buy-In, Renewal, Executive Sponsor Quit, Issue Resolution Achieved, Launch Risk, License Down sell, License Upsell, Logistical Issues, Logistical Issue Resolved, Loss of Budget, Low Usage, Next Touchpoint Scheduled, No Response, No ROI/Value, Not Wanting to Renew, Onboarding in Process, Potential Upsell, Product Objection, Product Training, Product Usage, Questions About the Product, Renew, ROI Value Achieved, Scaled Outreach.

In one embodiment, the template serves as a guidance for human classifiers or automated classifiers (e.g., machine learning classifiers) for labeling texts. The template may include label names, criteria, and examples for each label including keywords corresponding to the respective label. For example, the table below (Table 1) is an exemplary template that includes entity names, criteria defining the entity, and examples for each entity. The template may include any other information that provides guidance to human classifiers or machine learning classifiers.

TABLE 1

| Name | Example(s) |
|---|---|
| Action Item Accomplished | This PO [has been processed]. |
| Criteria: | [Please see attached] order confirmation for reference. |
| If someone completed an | [I am putting an order for] {PRODUCT}. |
| action item. | [Please find] the quote [attached]. |
| | The three {PRODUCT} [will be delivered] tomorrow. |
| Action Item not Completed | [Can you please process] this invoice? |
| Criteria: If there is an action | [Please add] hitch number 29369. |
| item to be done | [Please get this entered] at your earliest convenience and [send an order |
| | confirmation] to {NAME}. |
| | [Please let me know] when we can fill these units. |
| | [Can you provide me] with a quote? |
| Attempt to | [I'm sorry to have missed you] today. |
| Contact/Reschedule | [Not sure if you saw my last email] but was hoping to connect with you |
| Criteria: | before the end of the year. |
| Rescheduling a | Could you [please let me know if you received my previous email?] |
| meeting | My current meeting is running over. [Do you have availability later today to |
| Delaying a meeting | reschedule] our demo? |
| Trying to contact | Is there a way that we can [push it to one hour later]? |
| unsuccessfully | |
| Meeting conflicts | |
| Contract Renegotiation | I'll be happy to [offer you discounts.] |
| Criteria: | [I'm sorry I wasn't able to get that lower.] In my notes, I see that you |
| Terms of contract | budgeted for under 20k. |
| Length of contract | If I remember correctly, you asked that I try and [get it under 24k]. |
| Price/discounts | Definitely happy to give pricing information, though please know that [we |
| Billing length | don't want price to be a reason not to get to work together]. |
| Payment type | Can we get 40% [off?] |
| (annual/monthly) | |
| Price negotiation | |
| Any bonuses added to | |
| package (extra seat, | |
| free shipping) | |
| Redlines | |
| New language | |
| Adjustments/edits to | |
| contract | |
| Expiration | |
| Executive Buy-In | Anything you have that are upcoming developments that would [help my |
| Criteria: Someone who is | team even further understand the value proposition] would be great. |
| trying to get others in their | [My colleague, {NAME}, is interested in {NAME}] after I sent him some |
| workplace interested in | of the sample reports you shared with me. [He represents our |
| purchasing your product or | national/strategic accounts team] and I would love to get him a sample |
| service. | report that he can take back to his director. |
| | It sounds like the [{NAME} team would be very interested] in having a look |
| | at this. |
| | Can I try the plan that you offer to us for a week so I can [present to our |
| | management team?] |
| | [{NAME} is open to and excited about your proposal.] |

Table 1 illustrates a template with four labels, “Action Item not Completed,” “Attempt to Contact/Reschedule,” “Contract Renegotiation,” and “Executive Buy-In.” The named entity template development module 220 may specify guidelines and criteria that qualifies a text as a respective label. For example, criteria for qualifying as the label “Attempt to Contact/Reschedule” are rescheduling a meeting, delaying a meeting, trying to contact unsuccessfully and meeting conflicts. The template may further include specific examples to help with the labeling process. The named entity template development module 220 may further highlight/mark keywords in the exemplary texts, where the labels are determined based on the keywords. (In Table 1, the keywords are enclosed using square brackets.) The template generated by the named entity template development module 220 is used as a guidance for data labeling, which is discussed in further details in the data labeling module 230.

The data labeling module 230 labels textual data based on the template generated by the named entity template development module 220. The data labeling module 230 may also provide instructions to human classifiers to label training data based on the template. In one embodiment, the data labeling module 230 may label texts using a machine learning classifier that labels training data based on the template and the labeled data may be further verified by qualified human classifiers. In another embodiment, human classifiers may determine a label or multiple labels appropriate for a text. The data labeling module 230 may further instruct human classifiers to indicate (or mark) keywords that encapsulate the meaning of the label. In one embodiment, the human classifiers may use a software (e.g., Label Studio) to assign labels to training data. The data labeling module 230 may record starting index and ending index of the identified keywords. The data labeling module 230 may generate a training dataset with each row including an ID number (Identity Number), labels, keywords, starting and ending indices of keywords. The training dataset is then passed to the NER (named entity recognition) model training module 240 for model training.

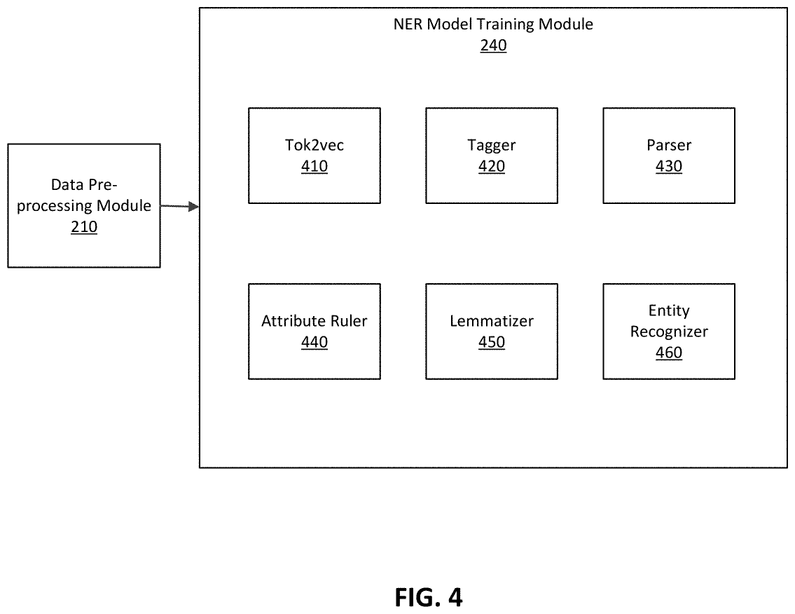

The NER (named entity recognition) model training module 240 trains an NER model using a pipeline of sub-models. FIG. 4 illustrates an exemplary training process for a named entity recognition system, according to one embodiment. Training data prepared by the data preprocessing module 210 may be first passed to a model Tok2vec 420 which transforms tokens to vectors, where a token may be a word in the texts. The Tok2vec model 420 may include subnetworks such as an embedding model and an encoding model, each being a neural network trained to embed tokens into vector representations or to encode context into the embeddings. The outputted vectors are passed to a tagger 420, which may be a linear layer of neural network that tags components for part-of-speech. The tagger 420 marks up a word in a text as corresponding to a particular part of speech, based on context of the text. Results outputted from the tagger 420 are passed to a parser 430 that analyzes syntactic structure of a text by performing analysis based on an underlying grammar. The NER model training module 240 may further include an attribute ruler 440 that allows user to set token attributes for identified tokens. The attribute ruler 440 may define rules for handling exceptions for token attributes. The lemmatizer 450 may assign base forms to such that variant forms of the base word can be analyzed as a single object. The entity recognizer 460 may, based on results generated from modules 410-450, predict one or more named entities for each text and identify keywords associated with the named entities. In one embodiment the entity recognizer 460 may use a beam-search algorithm as a decision making layer to choose the best output given results generated by modules 410-450. The entity recognizer 460 may, based on one or more loss functions, identify and predict a label with associated keywords. The NER model training module 240 may iteratively perform a forward pass that generates an error term based on one or more loss functions, and a backpropagation step that backpropagates gradients for updating a set of parameters. The NER model training module 240 may stop the iterative process when a predetermined criterion is achieved. The NER model training module 240 may determine error terms and calculate gradients which are backpropagated through the entire architecture of the NER model training module 240. The NER model training module 240 repeatedly updates the set of parameters for the prediction model by backpropagating error terms obtained from the loss function. This process is repeated until the loss function satisfies predetermined criteria. In one embodiment, the NER model training module 240 may further output a sentiment score that indicates a level of association between the text and the determined label. The sentiment scores may be further associated with polarities. For example, a sentiment score may be 56 positive, and another sentiment score may be 12 negative.

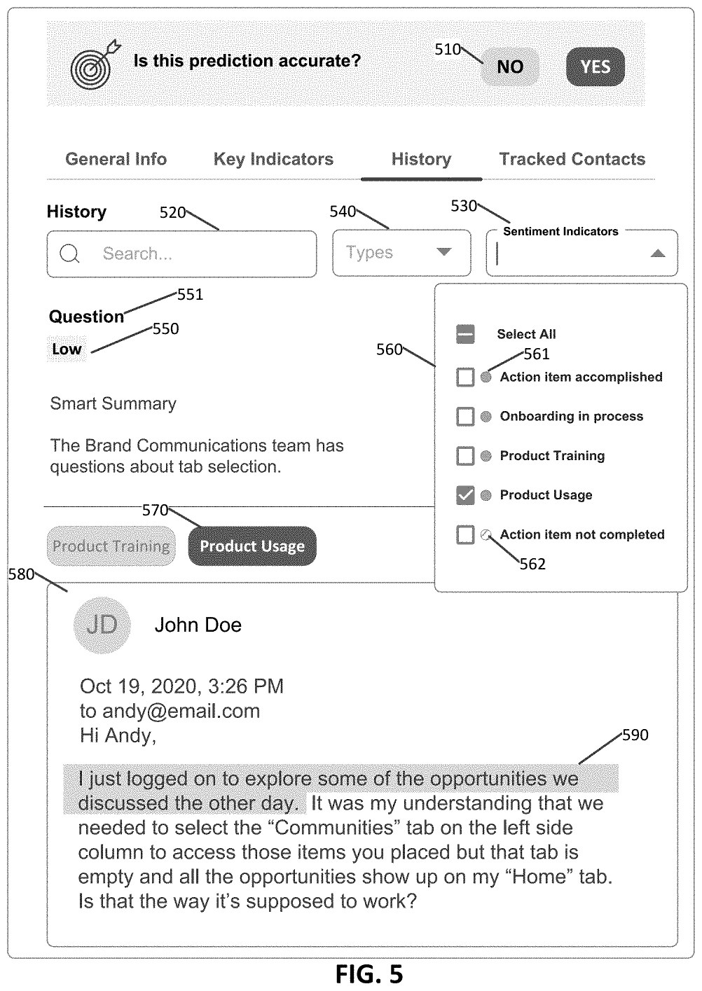

The NER model deployment module 250 deploys a trained model using real-world data. The NER model deployment module 250 may collect textual content items from the client 116 and deploy the model trained by the NER model training module 250. The NER model deployment module 250 may pass the collected raw data through the data preprocessing module 210 and then feed the clean data to the trained model. In one embodiment, the NER model deployment module 250 may output predicted labels associated with each text. NER model deployment module 250 may further output a polarity associated with each label and a sentiment score that indicate how negative/positive the label is. The outputs from the NER model deployment module 250 may be displayed through the user interface 140, which is discussed in further details in accordance with FIGS. 5-6.

FIG. 5 illustrates an exemplary user interface through which a user may access service provided by the named entity recognition system 130, according to one embodiment. The exemplary user interface illustrated in FIG. 5 may include buttons or areas where user may provide feedback regarding accuracy of predictions. For example, a user may click on buttons 510 for providing feedback to the generated predictions. The user interface 140 may further provide a search box 520 for searching history textual information and a box 540 for filtering on one or more types of communication to search from (e.g., emails or reviews.) The user interface also includes a box 530 for selecting and filtering on one or more sentiment labels. For example, a user may wish to see emails related to product usage, then the user may filter on emails in box 540 and “Product Usage” for box 530. Upon clicking in the box 530, a menu 560 may appear including available labels to select. Each label may be associated with an indicator such as indicators 561 and 562, each representing a type of polarity of the respective label. For example, indicator 561 illustrates a positive label and indicator 562 illustrates a negative label. The user interface may further provide a severity indicator 550 that is determined based on sentiment score. The severity indicator 550 may be numerical (e.g., displayed as sentiment scores in a scale of 1-10) or may be categorical such as “low,” “medium,” “high.” The user interface includes an area 580 for displaying the original textual data such as the email as illustrated in area 580. The original data is presented through the user interface with keywords 590 that encapsulate the respective label displayed in a visually distinguishable style (e.g., highlighted, circled, underlined, etc.) The user interface may further include tags 570 which enable a user to view marked up keywords for a specific label if a text is associated with multiple labels.

FIG. 6 illustrates another exemplary user interface through which a user may access service provided by the named entity recognition system 130, according to one embodiment. In FIG. 6, a negative label “Action item not completed” is selected through the filter 630. The negative label is distinguished from positive labels with a different indicator such as 610. The keywords 620 associated with the label are also marked in the original message 640 with a visually distinguishable style such as shaded as illustrated in 620, where the keywords 620 may be marked in a style that is consistent with the indicator 610.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for improving training data of a machine learning model through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined herein.

What is claimed is:

1. A named entity recognition model stored on a non-transitory computer readable storage medium, the model associated with a set of parameters, and configured to receive a set of features associated with unstructured texts, wherein the model is manufactured by a process comprising:
obtaining a training dataset, wherein the training dataset is generated by steps comprising:
retrieving a textual dataset that includes a plurality of texts;
cleaning the textual dataset by removing sensitive information;
developing a set of named entities, each named entity corresponding to an actionable item or an accomplished item;
recording a mapping between the textual dataset and the set of named entities, wherein the mapping is performed by human classifiers or machine learning classifiers based on a template that specifies criteria defining the set of named entities; and
generating the training dataset using a plurality of value pairs, wherein each value pair includes a first value and a second value, the first value being one or more key words and the second value being a named entity determined based on the one or more key words;
for the named entity recognition model associated with the set of parameters, repeatedly iterating the steps of:
obtaining an error term from a loss function associated with the named entity recognition model;
backpropagating an error term to update the set of parameters associated with the named entity recognition model;
stopping the backpropagation after the error term satisfies a predetermined criteria; and
storing the set of parameters on the computer readable storage medium as a set of trained parameters of the named entity recognition model.

2. The named entity recognition model of claim 1, wherein the set of named entities are each assigned a polarity, the polarity being a positive entity or a negative entity, wherein a positive entity corresponds to an entity associated with positive sentiment, and a negative entity corresponds to an entity associated with negative sentiment or an outstanding item to accomplish.

3. The named entity recognition model of claim 2, wherein developing the set of named entities further comprises, providing the template to the human classifiers, wherein the human classifiers label a text with a named entity and mark corresponding keywords in the text.

4. The named entity recognition model of claim 2, wherein each named entity of the set of named entities is associated with a polarity score that informs a sentiment score of the named entity.

5. The named entity recognition model of claim 2 further comprises a machine learning pipeline with a plurality of sub-models for recognizing named entities.

6. The named entity recognition model of claim 9, wherein the plurality of sub-models includes a tagger that tags each word in the text based on components of part-of-speech.

7. The named entity recognition model of claim 9, wherein the plurality of sub-model includes a lemmatizer that identifies a base form of a word.

8. The named entity recognition model of claim 1, wherein the textual dataset includes one or more of emails, support tickets, notes, call log, or webinar transcripts.

9. The named entity recognition model of claim 1, wherein cleaning the textual dataset comprises removing PII (personal identifiable information).

10. The named entity recognition model of claim 1, wherein cleaning the textual dataset comprises removing metadata persisted from data source using regular expression.

11. The named entity recognition model of claim 1, wherein cleaning the textual dataset comprises removing emails, phone numbers or website addresses using regular expression.

12. The named entity recognition model of claim 1, wherein cleaning the textual dataset comprises replacing sensitive information with tags.

13. The named entity recognition model of claim 1, wherein cleaning the textual dataset comprises converting data in HTML, format to txt format.

14. A method for performing sentiment labeling comprising:
receiving a content item containing texts;
identifying, based on the texts, a recognized named entity using the named entity recognition model of claim 1;
presenting, through a user interface, the recognized named entity; and
marking one or more keywords in the content item with a visually distinguishable style, through the user interface, wherein the recognized named entity is associated with the marked one or more keywords.

15. The method of claim 14, further comprising:
obtaining a sentiment score associated with the named entity; and
displaying the sentiment score through the user interface.

16. The method of claim 14, wherein the recognized named entity is marked as a positive entity or a negative entity, and wherein polarity of the named entity is displayed through the user interface with visually distinguishable characteristic cs.

17. The method of claim 14, wherein the user interface includes a dropdown menu that includes a plurality of recognized named entities identified in a plurality of textual content items.

18. The method of claim 14, further comprising displaying a level of severity associated with the named entity, the level of severity generated based on the sentiment score.

19. The method of claim 14, further comprising, responsive to a user filtering on a particular named entity, displaying textual content items associated with the filtered named entity.

20. The method of claim 14, further comprising, responsive to a user filtering on a particular type of named entities, displaying textual content items associated with the selected type of named entities.
